(19) United States
(12) Patent Application Publication
(10) Pub. No.: US 2008/0190547 A1
(43) Pub. Date: Aug. 14, 2008

(54) Protective layer for motor vehicle windshields

(75) Inventors: Murray White, Watertown, MI (US); Michael Julian, Iron Mountain, MI (US)

Correspondence Address: HEDMAN & COSTIGAN P.C., 1185 AVENUE OF THE AMERICAS, NEW YORK, NY, 10036, US

(73) Assignee: Julian/White, Partners LLC, Watertown, MI (US)

(21) Appl. No.: 11/705,681

(22) Filed: Feb. 13, 2007

(51) Int. Cl. B60J 1/20

(52) U.S. Cl. 156/108; 252/62.3 Q

(57) ABSTRACT

The invention is directed to protective plastic film for attachment to a plastic windshield for the purpose of providing a protective layer on said windshield wherein the plastic film may be polypropylene which may or may not be tinted.

### BACKGROUND OF THE INVENTION

Many motor vehicle such as motorcycles, All Terrain Vehicles (ATV's), farm tractors, go-karts and the like which are used on and off roads are provided with a windshield that is typically not made of glass but are made of impact resistant, clear plastic. These plastics may be polyacrylates, polycarbonates or other plastics that have surface characteristics that are different from the glass windshield typically used in automobiles and trucks. The surface of a clear plastic is typically softer and less smooth than a safety glass surface used in cars and trucks. In use, the plastic windshield presents a problem when it is necessary to clean the windshield to remove dirt that accumulates as a result of on or off road conditions. The dirt and insect debris that accumulate on a plastic windshield is not easily removed by wiping or washing the windshield because the nature of the plastic surface allows the dirt to become partially embedded in the surface due to the contact with the windshield at highway speeds. These same plastics are also subject to damage in the form of microchipping caused by road debris such as rocks and other hard objects.

The present invention is directed to providing a clear, removable protective film to a plastic windshield that will prevent dirt and debris from reaching the plastic windshield. The clear, removable protective film is designed to be easily completely removable without leaving any residue on the windshield that would prevent the reapplication of a removable protective film. This protective film will also reduce the tendency of the plastic windshield to exhibit microchipping.

### SUMMARY OF THE INVENTION

In its broadest concept, the invention comprises a clear, removable plastic film which is sized for attachment to a plastic windshield for the purpose of providing a protective layer on said windshield.

The invention also provides a method for protecting a plastic windshield, said method comprising providing a clear, removable plastic film on a surface of a plastic windshield for the purpose of providing a protective layer on said windshield. The plastic film is adapted to adhere to either side of a plastic windshield for extended periods of time and may be removed merely by lifting an edge and peeling the plastic film off of the plastic windshield. The film has a thickness that provides protection against dirt and insect debris that are typically encountered during either on or off road operation of the motor vehicle.

It is preferred to attach the plastic film to the side of the windshield that face the forward part of the vehicle but if desired, the plastic film may be attached to both sides of the windshield.

Accordingly it is a primary object of the invention to provide a method of protecting a plastic windshield from dirt and insect debris during on or off road operation.

It is also an object of this invention to provide a sized protective film for a windshield that may be removably adhered to a plastic windshield.

It is also an object of this invention to provide a system for eliminating the need to clean a plastic windshield by providing a disposable removable plastic film surface that is optically clear and may be removed when soiled and replaced by a new removable plastic film.

It is also an object of the invention to provide a protective plastic film on a plastic windshield that will adhere when exposed to a wide range of temperatures or when exposed to rain, sleet, ice or snow, but will still be readily removable.

These and other objects of the invention will become apparent from the appended specification.

### BRIEF DESCRIPTION OF THE DRAWINGS

FIG. 1 is schematic diagram of the system of the invention showing a windshield arranged around a headlight. A removable film is partially attached by placing an oversized film on the windshield.

FIG. 2 is a schematic diagram of a system of the invention showing a windshield arranged around a headlight where the removable film is shown partially rolled off of the windshield during the removal process.

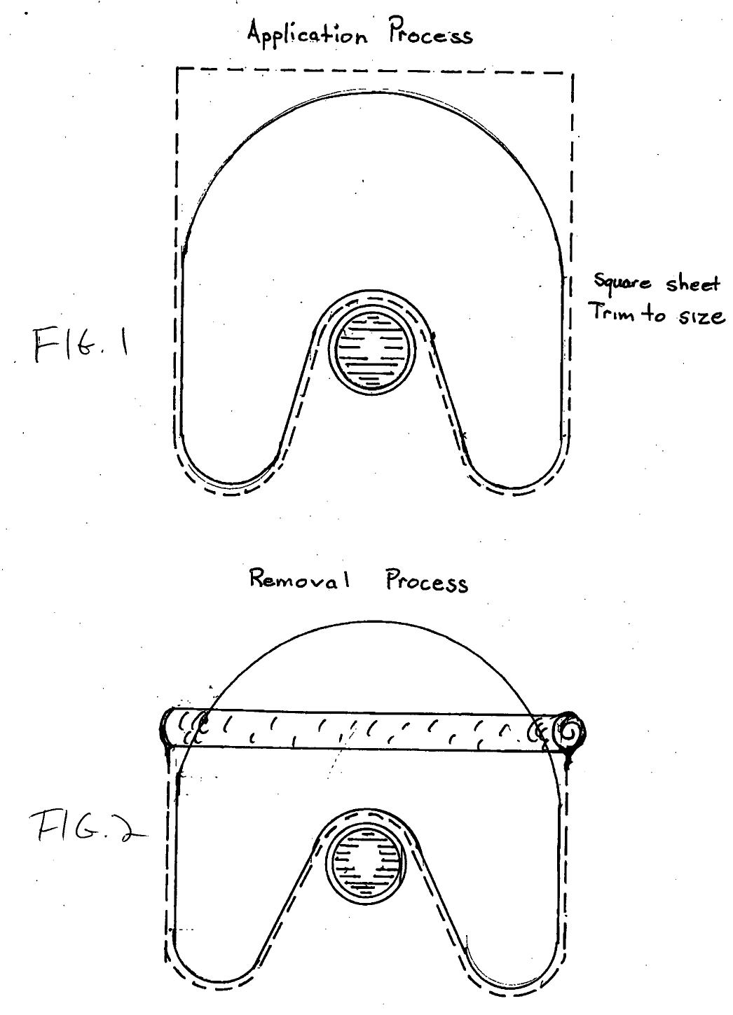

### DETAILED DESCRIPTION OF THE INVENTION

The preferred method for attaching a substantially optically clear plastic film to a plastic windshield is to utilize a static cling effect whereby a thin plastic film is adhered to a plastic windshield so that the plastic film does not slide or peel off under actual road conditions. The preferred material for the plastic film for use as a protective film is a polyolefin, a polycarbonate, a vinyl polymer, an acrylic, a polyester, e.g. polyethylene terephthalate or a silicone film having a thickness of 2 to 10 mils, preferably 6 to 9 mils and especially preferably 8 mils. Polyvinyl films are preferred and the preferred film is polyvinyl chloride. The plastic film may be unoriented or mono or bi-axially oriented and may be made by casting or extrusion or coextrusion. If desired a conventional plasticizer may be added to the polymer composition before it is formed. In addition, the plastic film may be a laminated structure having a thickness of 2-10 mils which utilizes the same or different plastic films in the form of a multilayer structure that is formed by using a suitable laminating adhesive to form a multilayer structure using conventional techniques.

Optionally, the plastic film may contain an ultraviolet light absorber in order to stabilize the film. Examples of these materials are well known and include those materials disclosed in Modern Plastics Encyclopedia (1989) pp. 190-192, which is incorporated by reference. The plastic film may optionally be tinted with colored materials that modify light transmission or impart an esthetic effect such as a color that compliments the color of the motorcycle. Colorants for this purpose are well known and are disclosed in Modern Plastics Encyclopedia (1989), pp. 148-150, which are incorporated by reference. If a colored material is present, the amount may be varied to provided the desired color. If a UV absorber is added to the film it should be present in an amount that provides a stabilizing effect toward UV light without imparting any substantial effect on visibility. Generally, this will be about 3-10 wt %.

In order to prevent glare or reduce the amount of sunlight or headlight that is transmitted through the windshield, a polarizing additive such as one of the materials described in U.S. Pat. No. 5,002,701, which is incorporate by reference, may also be optionally added to the film to reduce the glare of headlights and/or sunlight.

The preferred method of attaching the removable film is by using static cling, i.e. the electrostatic attraction of a polyolefin for an acrylate or polycarbonate plastic surface.

If desired, a commercially available removable adhesive or an ultra-removable may be used be used to form a secure but removable bond of the plastic film to the plastic windshield. If an adhesive is used, the level of the adhesive coating should be from about 0.1 to 1.0 mils.

The removable film may be pre-cut as an exact fit for a particular windshield or it may be provided as an oversize piece of plastic film that is sized to extend over the edges of a plurality of plastic windshields with the intent that the user will apply the plastic film to a plastic windshield and then cut the edges off to provide a custom fit for any particular windshield. Whether a removable film is sized to fit a particular windshield or is sized to be trimmed to fit a series of windshields, the basic installation method of adhering the plastic film to the windshield contemplates pressing the plastic film, onto the windshield in such a manner that air bubbles and wrinkles are avoided and a tight adherent fit is achieved between the plastic film and the plastic windshield.

A suitably sized rubber, plastic or wooden roller may be used to insure that the surface of the plastic film is in close contact with the surface of the plastic windshield. Optionally a damp or dry cloth may be used to pressing the plastic film onto a windshield.

The plastic film may be removed by carefully lifting an edge using a fingernail. Optionally a putty knife or razor may be used to lift an edge prior to slowly and carefully stripping off the plastic film. If a new plastic film is to be applied it may be directly applied without further preparing the windshield. Prior to the initial application of a plastic film to a plastic windshield, it is necessary to remove any dirt or insect debris prior to applying a plastic film.

I claim:

1. A plastic film which is sized for attachment to a plastic windshield for the purpose of providing a protective layer on said windshield.

2. A plastic film as defined in claim 1 wherein the film is a vinyl polymer.

3. A plastic film as defined in claim 1 wherein the film is a polyvinyl chloride polymer.

4. A plastic films defined in claim 1 wherein the plastic film includes a material that imparts a tint to said plastic film.

5. A plastic film as defined in claim 1 wherein the film is a laminate of two or more plastic films.

6. A plastic film as defined in claim 1 wherein the plastic film has a thickness of 2-10 mils.

7. A plastic film as defined in claim 1 where the plastic film is adhered with an adhesive.

8. A plastic film as defined in claim 1 where the plastic film is adhered by static cling forces.

9. A method for protecting a plastic windshield, said method comprising providing a clear, removable plastic film on a surface of a windshield for the purpose of providing a protective layer on said windshield.

10. A method as defined in claim 8 wherein the removable plastic film is a vinyl polymer.

11. A method as defined in claim 10 wherein the removable plastic film is a polyvinyl chloride polymer.

12. A method as defined in claim 8 wherein the removable plastic film is sized to fit the plastic windshield.

13. A method as defined in claim 8 wherein the removable plastic film is sized to fit over the edges of a plurality of plastic windshields.

14. A method as defined in claim 8 wherein the plastic film is a laminate of two or more plastic films.

15. A method as defined in claim 8 where the plastic film is adhered with an adhesive.

16. A method as defined in claim 8 where the plastic film is adhered by static cling forces.
